(19) United States
(12) Patent Application Publication
(10) Pub. No.: US 2015/0158701 A1
(43) Pub. Date: Jun. 11, 2015

(54) LOW-RISE ELEVATOR

(71) Applicant: ThyssenKrupp Elevator Corporation, Atlanta, GA (US)

(72) Inventors: Frank P. Dudde, Collierville, TN (US); Peter P. Feldhusen, Collierville, TN (US); Alan M. Parker, Byhalia, MS (US); Stephen D. Allen, Middleton, TN (US); Jie Xu, Cordova, TN (US); Mike Palazzola, Horn Lake, MS (US)

(73) Assignee: ThyssenKrupp Elevator Corporation, Atlanta, GA (US)

(21) Appl. No.: 14/102,429

(22) Filed: Dec. 10, 2013

(51) Int. Cl. B66B 11/06; B66B 1/24; B66B 7/06; B66B 9/00; B66B 11/00

(52) U.S. Cl. CPC B66B 11/06; B66B 9/00; B66B 11/0045; B66B 11/0075; B66B 7/062; B66B 1/24; B66B 11/0005

(57) ABSTRACT

One or more drum winches wind and unwind flat suspension members to raise and lower an elevator car within a hoistway. Support structures on opposite sides of the hoistway support the winch(es). The flat suspension member may be attached to a termination point on the elevator car. In other examples, a single flat suspension member is simultaneously taken up by a winch on either side of the hoistway, passing down the sides and around the bottom of the elevator car. In a third example, a single winch takes up and lets down the flat suspension member, which passes down the side of the elevator car, around the bottom corners using deflector sheaves, and up the opposite side to a termination point mounted on one of the support structures. The profile ratio of the flat suspension member is at least about 10:1, 50:1, or at least about 90:1.

### FIELD

The present invention relates to elevators. More specifically, the present invention relates to main component parts of lifts in, or associated with, buildings or other structures, namely driving gear with hoisting member positively attached to a winding drum.

### BACKGROUND

In the field of elevators, it is desirable to minimize the amount of building space taken by the elevator hoistway and the equipment used to raise and lower the elevator car(s). While there may be devices and methods that attempt to accomplish this, it is believed that no one prior to the inventor(s) has made or used an invention as described herein.

### BRIEF DESCRIPTION OF THE DRAWINGS

It is believed that the present invention will be better understood from the following description of certain examples taken in conjunction with the accompanying drawings, in which like reference numerals identify like elements.

FIG. 1 is a schematic drawing of an elevator system according to one embodiment.

FIG. 2 is a perspective drawing of the elevator system of FIG. 1.

FIG. 3 is a schematic drawing of an elevator system according to a second embodiment.

FIG. 4 is a schematic drawing of an elevator system according to a third embodiment.

FIG. 5 is a schematic drawing of a drum winch for use with various embodiments.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the descriptions serve to explain the principles of the invention; it being understood, however, that this invention is not limited to the precise arrangements shown.

### DESCRIPTION

The following description and certain examples of the invention should not be used to limit the scope of the present invention. Other examples, features, aspects, embodiments, and advantages of the invention will become apparent to those skilled in the art from the following description. As will be realized, the invention is capable of other different and obvious aspects, all without departing from the invention. Accordingly, the drawings and descriptions should be regarded as illustrative in nature and not restrictive.

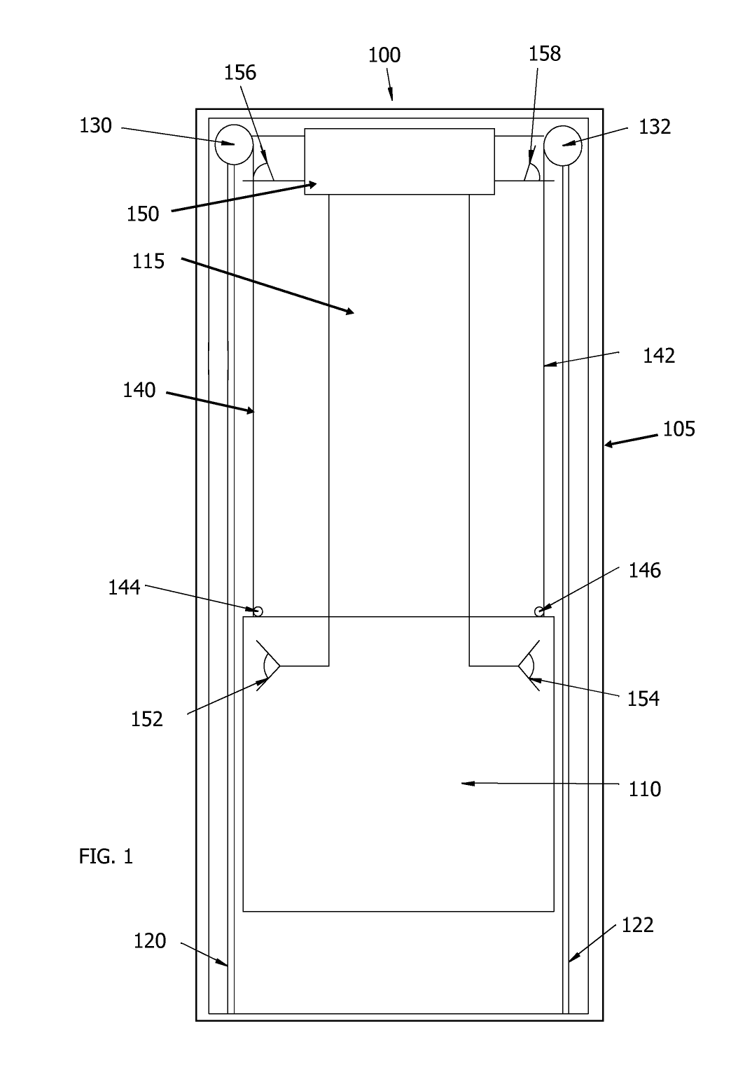

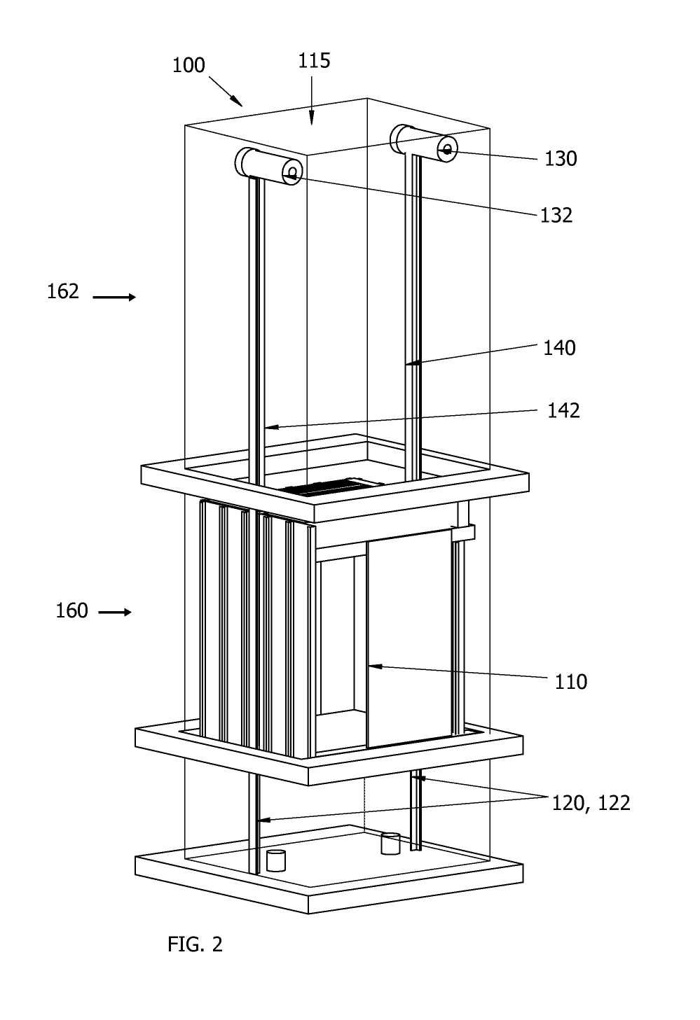

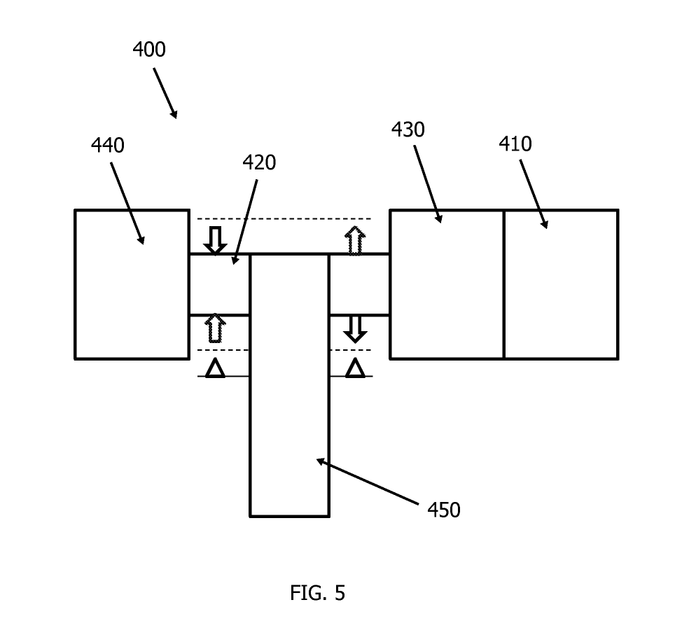

Generally, one form of the present system is an elevator having an elevator car suspended by a flat cable attached to a drum winch above, as illustrated in FIGS. 1-2. As shown in FIG. 1, elevator system 100 in building 105 provides for raising and lowering of elevator car 110 through hoistway 115. Support structures 120 and 122 support winches 130 and 132, respectively. Winches 130 and 132 are preferably drum-type winch subsystems as will be discussed below in relation to FIG. 5, though other embodiments will occur to those skilled in the art in view of this disclosure. Support structures 120 and 122 in this embodiment are supported vertically at or near their bases, and they are supported against horizontal movement by attachment to the walls of hoistway 115 and/or other attachments to portions of building 105 as will occur to those skilled in the art.

Elevator car 110 is suspended in this embodiment below winches 130 and 132 by flat suspension member sets 140 and 142, respectively. Termination point 144 for the flat suspension member set 140 and termination point 146 for flat suspension member set 142 are attached (preferably symmetrically about the car's center of mass, though not necessarily so) to the top of elevator car 110 to connect elevator car 110 to the supporting suspension member sets 140 and 142. It is observed that no deflector sheaves are needed for this design.

In this embodiment, synchronization device 150 includes circuitry that takes input from displacement sensors 152, 154, 156 and 158 and differentially drives winches 130 and 132 to keep elevator car 110 level. For example, displacement sensors 152 and 154 each measure the distance between the side of elevator car 110 and the wall of hoistway 115. If displacement sensor 152 detects that elevator car 110 is too close to the wall of hoistway 115, then synchronization device 150 controls winch 130 to allow more of flat suspension member set 140 to be let out (or, equivalently, not to be taken in) relative to operation of winch 132 on flat suspension member set 142. Alternatively or additionally, displacement sensors 156 and 158 measure the distance from their fixed position to the outermost turn of flat suspension member set 140 or 142 (respectively), from which it can be inferred how much of flat suspension member 140 or 142 is hanging between winch 130 or 132 and the respective termination point 144 or 146. With information regarding the horizontal position of elevator car 110 in hoistway 115 and/or the differential height of termination points 144 and 146, synchronization device 150 keeps elevator car 110 properly oriented (e.g., level) both during movement and at rest.

Using additional or alternative sensors, synchronization device 150 measures the torque exerted by winches 130 and 132 and/or directly measures the vertical distance between elevator car 110 and one of winches 130 and 132 (or another defined point) to obtain information about the position and orientation of elevator car 110. Synchronization device 150 then differentially operates winches 130 and 132 to maintain the desired position and orientation of elevator car 110.

FIG. 2 is a perspective view of elevator system 100 from FIG. 1. Again, elevator system 100 comprises drum winches 130 and 132, each holding and operating a flat suspension member 140 and 142, respectively, to control movement of elevator car 110 between first-floor position 160 and second-floor position 162. Support structures 120 and 122 are situated between the sides of elevator car 110 and the walls of hoistway 115, supporting respective winches 130 and 132 at a position near the top of hoistway 115.

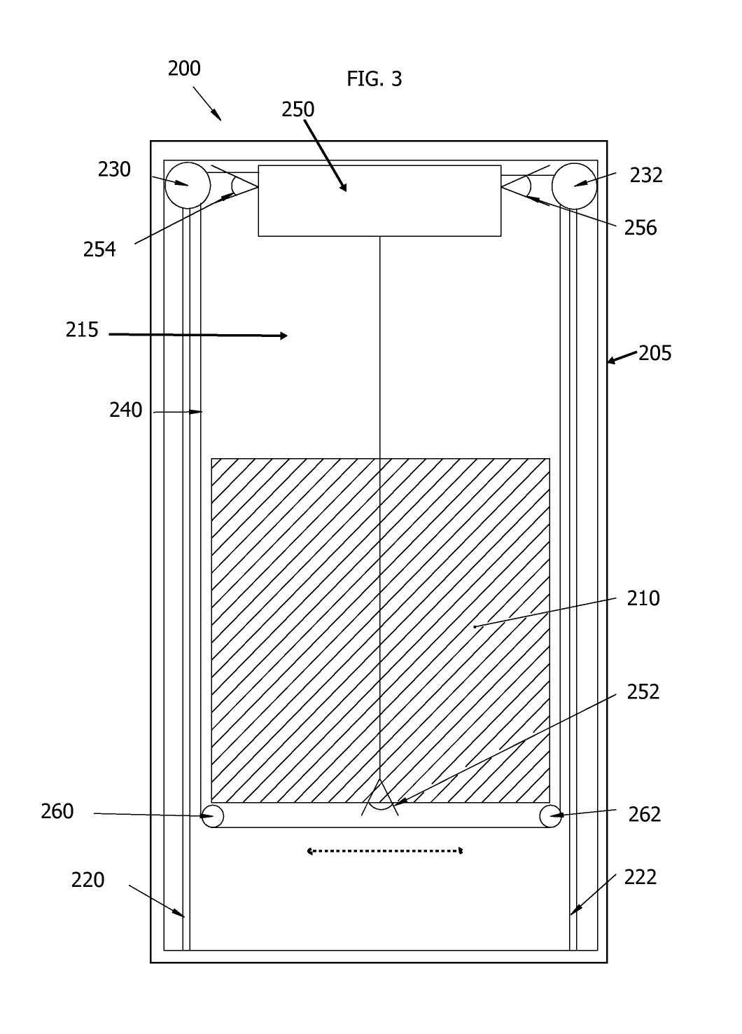

In an alternative embodiment illustrated in FIG. 3, elevator system 200 includes elevator car 210, which is raised and lowered through hoistway 215. In this system, support structures 220 and 222 support drum winches 230 and 232, respectively. Support structures 220 and 222 are again supported in the vertical dimension at and/or near the bottom of each one, and they are preferably supported against horizontal movement along their length by one or more attachments (not shown) to the outside of hoistway 215 or other structural element of building 205.

In this exemplary embodiment, a single flat suspension member set 240 runs from winch 230 down along the side of elevator car 210, around deflector sheaves 260 and 262 (attached to respective bottom corners of elevator car 210), and up along the opposite side of elevator car 210 to winch 232.

Synchronization device 250 takes input from displacement sensors 252, 254, and 256 as inputs into a control circuit that controls the position and orientation of elevator car 210. In this embodiment, displacement sensor 252 detects the displacement between flat suspension member set 240 as it runs along the bottom of elevator car 210 and the bottom of elevator car 210 itself. Alternatively or additionally, displacement sensors 254 and 256 detect the outer diameter of drum winch 230 or 232, respectively, including the thickness of the wound portion of flat suspension member 240 on each drum. When lateral displacement is detected by displacement sensor 252, or an unexpected differential is detected between the outer diameters of drum winches 230 and 232 by displacement sensors 254 and 256, respectively, synchronization device 250 differentially drives winch 230 and winch 232 to correct the misalignment. Of course, other position/attitude sensing and correction systems may be used as will occur to those having ordinary skill in the art.

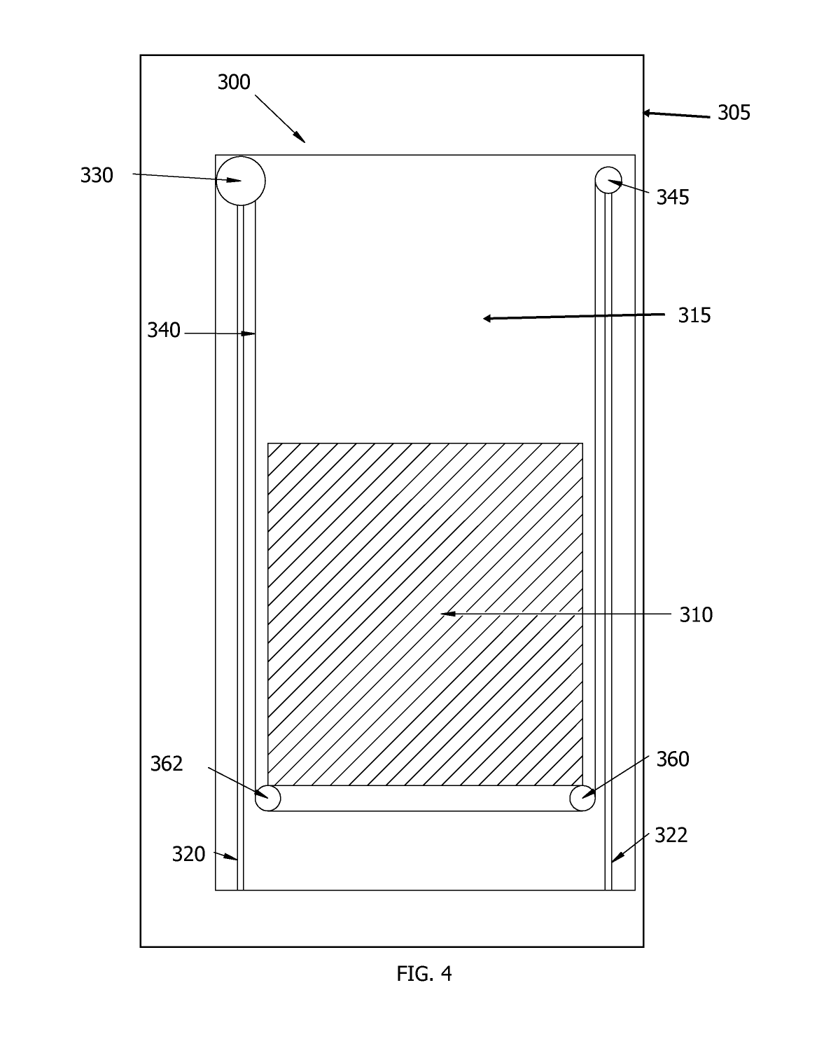

FIG. 4 illustrates a third elevator system 300, which moves elevator car 310 up and down hoistway 315 in building 305. In this exemplary embodiment, support structure 320 runs along one side of hoistway 315 to support winch 330 at or near the top, while support structure 322 runs along the opposite side of hoistway 315 to support suspension member termination point 345. Flat suspension member set 340 ends at suspension member termination point 345, running down one side of elevator car 310, around deflector sheaves 360 and 362 on opposite corners of the bottom of elevator car 310, and up the opposite side of elevator car 310 to drum winch 330. Drum winch 330 rotates to take in more or less of flat suspension member set 340 to raise and lower elevator car 310. Because elevator system 300 includes only a single winch in this embodiment, no synchronization between multiple winches is needed.

In some embodiments, the elevator car is a frameless, full-steel, lightweight car made from bended sheet metal. The car's outer dimensions are optimized to allow use in small hoistways with the maximum inside dimensions that are permissible under relevant building codes. Of course, alternative embodiments will have different characteristics is these respects.

Turning to FIG. 5, an exemplary drum winch 400 is illustrated for use with the disclosed systems. Motor 410 produces rotational energy to drive drum 420 by way of gear box 430. On the opposite end of drum 420, brake 440 includes components and subsystems capable of slowing and/or stopping the rotation of drum 420 as needed to manage the speed and position of the associated elevator car. In this sort of embodiment, the brake 440 and a torque limiter (not shown) can be part of winch subsystem 400. Compared with other types of winches and elevator equipment, drum winches usable in the present embodiments are light in weight and small given particular design parameters, including nominal load, number of stops, and speed.

In various embodiments, motor 410 is a four- or six-pole synchronous motor with an attached planetary drive that has a reduction factor appropriate for the design criteria. Permanent magnet motors can also be used, either with or without a gear box. Still other alternative embodiments use regenerative drives.

Brake 440 is, in some embodiments, a one, two, or multi-step step brake. If the operational brake is not part of winch subsystem 400, it is mounted on the car and acts on at least one support structure. If the brake is mounted to the car, it is combined in some embodiments with safety gear. Each drum uses at least one flat suspension member 450 to support the elevator car. In the illustrated embodiments, the flat suspension members have a thickness of about one (1) millimeter, though other thicknesses will occur to those having skill in the art in view of this disclosure. The width of the flat suspension member 450 is ninety (90) millimeters in some embodiments, and in others one hundred twenty (120) millimeters, as described in Table 1, which shows exemplary belt characteristics.

TABLE 1

Belt Type

| | A | B |
|---|---|---|
| THICKNESS (mm) | 1 | 1 |
| Width (mm) | 90 | 120 |
| Breaking Strength (KN) | 124.7 | 166.3 |
| Safety Factor | 12 | 12 |

Other configurations of flat suspension members 450 will occur to those skilled in the art in view of the present disclosure.

The “profile ratio” of a flat suspension member is defined for the purposes of this description as the proportion between the “width” (i.e., longest dimension) and “thickness” (measured as the greatest thickness measured perpendicular to the width) of a typical cross section of the flat suspension member in the region that is taken up by the drum winch as the elevator car travels between its lowest and highest extents. So defined, flat suspension members for use with the present invention may have a profile ratio that is at least about 10:1, though this profile ratio is preferably at least about 50:1. More preferably, the profile ratio is at least about 90:1, and in some embodiments the profile ratio is at least about 120:1.

Of course, the larger the cross section, the more material there is through which to distribute the tension resulting from the weight of the car, but as the thickness of the flat suspension member 450 increases, the diameter of the drum 420 and its windings increases that much for each rotation of the drum 420, and more space must be allocated for the drum 420 and its windings. In addition, as the diameter of the combined drum 420 and windings increases, the torque needed to take up the flat suspension member 450 at a constant linear rate increases, putting more demand on the motor 410.

Exemplary specifications for the drum winch are shown in Table 2. The diameter of the empty drum 420 is eighty (80) millimeters, and after taking up enough of flat suspension member 450 to raise the elevator car to the sixth floor, based on the assumptions below, it reaches just one hundred sixty (160) millimeters. For a two-stop elevator system, the drum and windings reach only one hundred one (101) millimeters in diameter in some embodiments, though initial windings needed to terminate the flat suspension member 450 on the winch and the thickness tolerances of the flat suspension member 450 may sometimes yield an outer diameter up to thirty percent (30%) larger than the theoretical thickness shown below.

TABLE 2

| | | Number of Stops | | | | |
|---|---|---|---|---|---|---|
| | | 2 | 3 | 4 | 5 | 6 |
| | | Stop | Stop | Stop | Stop | Stop |
| Distance between Coils in | 20 | | | | | |
| mm | | | | | | |
| Belt Thickness mm | 1 | | | | | |
| Drum Core Diameter mm | 80 | | | | | |
| Travel Height in mm | 0 | 3000 | 6000 | 9000 | 12000 | 15000 |
| Max. Drum Outer Diameter | 80 | 101 | 118 | 134 | 147 | 160 |
| in mm | | | | | | |

The selection of planetary gear boxes 430 for use in the embodiments shown in FIGS. 1-3 may be made by those skilled in the art as a function of the number of stops, the speed, and the nominal load of the elevator car. For example, gear boxes manufactured by Loenne as models PG 101 F, PG 161 F, PG 251 F, PG 501 F, PG 701 F, and PG 1001 F have been found satisfactory in various configurations for nominal car speeds 0.51, 0.76, and 1 m/s.

While the various embodiments have been illustrated as using a specific number of sheaves, it should be understood that the number and placement of sheaves could be different, as will be understood by those having ordinary skill in the art. For example, though certain embodiments have been shown using two sheaves placed on the bottom of the elevator car, other embodiments may use three sheaves, one sheave, or none at all, and some or all of them might be placed on the top of the elevator car.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. An elevator system in a hoistway in a building, comprising:
an elevator car;
at least one drum winch;
a first flat suspension member having a first end and a second end, where the first end is attached to the drum winch, and wherein the first flat suspension member vertically supports the elevator car.

2. The system of claim 1, further comprising two vertically extending support structures, wherein
each drum winch is supported by at least one of the support structures; and
each support structure is horizontally supported primarily by a hoistway wall.

3. The system of claim 2,
further comprising one or more sheaves attached to the elevator car; and
wherein the second end of the first flat suspension member is attached to one of the support structures; and
between the first end and the second end, the first flat suspension member passes around the one or more sheaves so that the elevator car rises as the drum winch takes up the first flat suspension member.

4. The system of claim 2, wherein
the one or more drum winches comprise a first drum winch and a second drum winch;
the first flat suspension member passes from the first drum winch, around one or more sheaves, and to the second drum winch so that the elevator car rises when both the first drum winch and the second drum winch take up the first flat suspension member.

5. The system of claim 2,
further comprising a second flat suspension member having a first end and a second end; and wherein
the one or more drum winches comprise a first drum winch and a second drum winch;
the first end of the first flat suspension member is attached to the first drum winch;
the first end of the second flat suspension member is attached to the second drum winch;
the second end of the first flat suspension member and the second end of the second flat suspension member are attached to the elevator car so that the elevator car rises when both the first drum winch and the second drum winch take up their respective suspension members.

6. The system of claim 1, wherein the elevator car, the drum winch, and the flat suspension member are all situated within the hoistway.

7. The system of claim 1, wherein the at least one drum winch comprises two or more winches, further comprising a means for synchronizing the winches.

8. The system of claim 1, wherein the flat suspension member has a profile ratio at least about 10:1.

9. The system of claim 1, wherein the flat suspension member has a profile ratio at least about 50:1.

10. The system of claim 1, wherein the flat suspension member has a profile ratio at least about 90:1.

11. A method of lifting an elevator car in a hoistway in a building, comprising the steps of:
placing a load in the elevator car;
turning one or more drum winches to take up one or more flat suspension members, wherein
the one or more flat suspension members are each connected to at least one of the one or more drum winches; and
the one or more flat suspension members collectively support the elevator car.

12. The method of claim 11, wherein
the one or more flat suspension members comprise a first suspension member and a second suspension member, each having a top end and a bottom end;
the one or more drum winches comprise a first drum winch and a second drum winch;
the top end of the first suspension member is attached to the first drum winch;
the top end of the second suspension member is attached to the second drum winch;
the bottom end of the first suspension member and the bottom end of the second suspension member are attached to the elevator car.

13. The method of claim 12, further comprising:
detecting at least one of
the distance between a side of the elevator car and a side of the hoistway, and
the size of at least one of the at least one drum winches at a point where the at least one drum winch has taken up at least a portion of one of the flat suspension members; and
managing the orientation of the elevator car within the hoistway by controlling the first drum winch relative to the second drum winch as a function of the results of the detecting step.

14. The method of claim 11, wherein
the one or more flat suspension members comprise a first suspension member that has a first end and a second end;
the one or more drum winches comprise a first drum winch and a second drum winch;
the first end of the first suspension member is attached to the first drum winch;
the second end of the first suspension member is attached to the second drum winch; and
between the first end and the second end of the first suspension member, the first suspension member passes around one or more sheaves, each of the one or more sheaves being attached to the elevator car.

15. The method of claim 14, further comprising:
detecting at least one of
the position of the first suspension member along the bottom of the elevator car, and
the size of at least one of the at least one drum winches at a point where the at least one drum winch has taken up at least a portion of one of the flat suspension members; and
managing the orientation of the elevator car within the hoistway by controlling the first drum winch relative to the second drum winch as a function of the results of the detecting step.

16. The method of claim 11, wherein
the one or more flat suspension members comprise a first suspension member that has a first end and a second end;
the one or more drum winches comprise a first drum winch and a second drum winch;
the first end of the first suspension member is attached to the first drum winch;
the second end of the first suspension member is attached to the a substantially fixed point separate from the elevator car; and
between the first end and the second end of the first suspension member, the first suspension member passes around one or more sheaves, each of the one or more sheaves being attached to the elevator car.

17. The method of claim 11, wherein the one or more flat suspension members have a profile ratio at least about 10:1.

18. The method of claim 11, wherein the one or more flat suspension members have a profile ratio at least about 50:1.

19. The method of claim 11, wherein the one or more flat suspension members have a profile ratio at least about 90:1.
